(19) United States
(12) Patent Application Publication
(10) Pub. No.: US 2010/0316227 A1
(43) Pub. Date: Dec. 16, 2010

(54) METHOD FOR DETERMINING A FREQUENCY RESPONSE OF A HEARING APPARATUS AND ASSOCIATED HEARING APPARATUS

(75) Inventor: Christoph Konrad Schmid, Erlangen (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/813,033

(22) Filed: Jun. 10, 2010

(30) Foreign Application Priority Data
Jun. 10, 2009 (DE) 10 2009 024 577.4

(51) Int. Cl. H04R 29/00

(52) U.S. Cl. 381/60

(57) ABSTRACT

A method determines a frequency response of a hearing apparatus in any acoustic environment situation as well as an associated hearing apparatus. Here the frequency response of the hearing apparatus is determined in dependence on at least one preset, user-independent frequency response and at least one user-dependent frequency response. As a result, a frequency response is advantageously prespecified to the user of the hearing apparatus in any acoustic environment situation, said frequency response being individually matched to said wearer.

### CROSS-REFERENCE TO RELATED APPLICATION

This application claims the priority, under 35 U.S.C. §119, of German application DE 10 2009 024 577.4, filed Jun. 10, 2009; the prior application is herewith incorporated by reference in its entirety.

### BACKGROUND OF THE INVENTION

### Field of the Invention

The invention relates to a method and a hearing apparatus for determining a frequency response of a hearing apparatus in any acoustic environment situation.

The acoustic ambient is composed of countless different situations. A modern hearing apparatus is to be automatically adjusted in as imperceptible a fashion as possible to each of these auditory situations, in order to be able to offer its user optimal speech intelligibility and user-friendliness. On this account, modern hearing apparatuses have different hearing programs. A specific parameter set, which includes for instance the individual signal processing parameters frequency response, amplification model, compression and control speed, directional microphone technology, background noise suppression, feedback elimination, wind noise suppression, reverb suppression, is characteristic of a hearing program. Each of these parameter sets represents the adjustment of all signal processing parameters for a certain acoustic hearing environment situation, the adjustment being meaningfully matched to one another. It is known that the acoustic hearing environment situation can be divided into at least four main categories “quiet situation”, “speech in noise”, “noise” and “music”.

Known modern hearing apparatuses, in the switched-on state, permanently analyze the current acoustic environment, and extract the so-called features therefrom and assign one of the four main categories to the current acoustic hearing environment with the aid thereof. The parameter set stored in the programmable hearing apparatus for the selected main category is activated and the operating parameter of the hearing apparatus is adjusted according to the parameter set. This technology is referred to as automatic environmental management. The setting of the individual parameters of a parameter set is decisive for the quality of the automatic environmental management. Two different approaches are known here.

The first approach, which is referred to below as automatic hearing test-based environmental management, is characterized in that the individual parameters of the respective parameter sets are individually set for the hearing-impaired person by the hearing device acoustician within the scope of adjusting the hearing apparatus. The hearing device acoustician measures the audiometric characteristics of the hearing, like for instance the degree of hearing loss, the level of discomfort and the volume scaling. The individual parameters of the assigned parameter sets are then defined for different hearing situations by way of hearing tests and are stored in the hearing apparatus. The advantage of the automatic hearing test-based environmental management lies in it being possible to individually set the parameter sets to the wearer of the hearing apparatus. The complexity of the selection method associated therewith nevertheless at the same time also represents the weakness of this approach. During the adjustment sessions with the hearing device acoustician, the hearing-impaired person is requested to decide on a concrete value combination from a very large number of theoretically possible configurations of a parameter set. Therefore with nine parameters, each having only two assumed possible values, there is already a total of 512 individual configurations, from which the wearer of the hearing apparatus has to make his/her choice. It should also be taken into account that the two underlying parameter sets must be harmonized in the case of a changeover from one hearing environment class to another, in order to offer the wearer of the hearing apparatus a smooth changeover, so-called fading, into the new hearing environment. The free definition of the individual parameter sets performed during the automatic hearing test-based environmental management may result in parameter settings being selected which do not ensure a smooth changeover when changing into a new environmental class.

The second approach, which is referred to below as preset, automatic environmental management, is characterized in that the individual parameters of the respective parameter sets are preset by the respective manufacturer of the hearing apparatus and are stored in the hearing apparatus. An individual adjustment and setting of the individual parameter sets is also performed for this hearing apparatus within the scope of the adjustment of the hearing apparatus by the hearing device acoustician. In automatic environmental management, these individually set parameter sets are however not automatically taken into account, but can instead only be manually set by the wearer of the hearing apparatus by selecting a corresponding program. On account of the predetermined basic quantity of parameter sets available for selection, the advantage of this approach lies in the fact that the afore-described complexity of the selection method and of the smooth changeovers from one parameter class into another is reduced and is thus more easily controllable. The disadvantage of the approach of the preset automatic environmental management is the reduced setting possibility of the parameter sets for the individual hearing environment classes. The preset parameter values relate to statistical and empirically obtained values and frequently fail to fulfill the individual requirements of the wearer of the hearing apparatus.

### SUMMARY OF THE INVENTION

It is accordingly an object of the invention to provide a method for determining a frequency response of a hearing apparatus and an associated hearing apparatus which overcome the above-mentioned disadvantages of the prior art methods and devices of this general type, which specifies an improved method for determining a frequency response of a hearing apparatus in any acoustic environment situation as well as an associated hearing apparatus.

With the foregoing and other objects in view there is provided, in accordance with the invention a method for determining a frequency response of a hearing apparatus in any acoustic environment situation. The method includes the step of determining the frequency response of the hearing apparatus in dependence on at least one preset, user-independent frequency response and at least one user-dependent frequency response.

The idea behind the invention consists in combining the advantages of the preset automatic environmental management and the hearing test-based environmental management. In a specific hearing environment, during the determination of the frequency response, the programmable hearing apparatus takes the hearing test-based and also the preset proposal for a frequency response into account and determines therefrom a frequency response which is offered to the wearer of the hearing apparatus.

The invention claims a method for determining a frequency response of a hearing apparatus in any acoustic environment situation. Here the frequency response of the hearing apparatus is determined in dependence on at least one preset, user-independent frequency response and at least one user-dependent frequency response. As a result, a frequency response is advantageously specified to the wearer of the hearing apparatus in any acoustic environment situation, the frequency response being individually matched to the wearer.

The user can preferably be a wearer of the hearing apparatus.

In a further embodiment, the user-dependent frequency response can be determined within the scope of audiological tests. This is advantageous in that the frequency response determined in this way is individually matched to the wearer of the hearing apparatus.

In a further embodiment of the invention, the quantity of parameter settings offered during the audiological tests for determining the user-dependent frequency responses can be restricted in accordance with predefinable criteria. This is advantageous in that the wearer of the hearing apparatus is able in this way to only select such parameter sets which ensure a smooth changeover when switching into a new hearing environment class.

The user-dependent frequency response and the preset, user-independent frequency response can preferably be stored in a storage unit of the hearing apparatus. This herewith ensures that both frequency response types are available for retrieval at any time in the hearing apparatus for further processing steps.

In a further embodiment, the frequency response of the hearing apparatus is determined, by the difference, weighted with a predeterminable weighting factor, between a user-dependent frequency response and the preset, user-independent frequency response being added to a preset, user-independent frequency response. If the preset, user-independent frequency response amounts to 60 dB for instance for an identified hearing situation and the user-dependent frequency response amounts to 50 dB, with a factor of 0.9, the frequency response of the hearing apparatus is calculated using the equation 60 dB+0.9*(50 DB−60 db)=51 dB. The weighting factor advantageously sets whether and the degree to which, during determination of the frequency response of the hearing apparatus, the preset user-independent frequency response or the user-dependent frequency response is to be weighted.

The invention also claims a hearing apparatus for determining a frequency response in any acoustic environment situation. The hearing apparatus includes a frequency response determination unit, by which the frequency response of the hearing apparatus can be changed as a function of at least one preset, user-independent frequency response and at least one user-dependent frequency response.

In a further embodiment, the hearing apparatus can include a storage apparatus for storing preset, user-independent frequency responses and user-dependent frequency responses.

In a further embodiment of the invention, the hearing apparatus can include a data input apparatus, which is connected to the storage apparatus. As a result, the input of data for storing preset, user-independent frequency responses and user-dependent frequency responses is advantageously enabled.

The hearing apparatus can also include a setting apparatus to enable the weighting factor to be changed by the wearer of the hearing apparatus. The wearer of the hearing apparatus is thus enabled to make his/her own changes to the weighting factor in the operating state.

The hearing apparatus can also be a hearing device.

Other features which are considered as characteristic for the invention are set forth in the appended claims.

Although the invention is illustrated and described herein as embodied in a method for determining a frequency response of a hearing apparatus and an associated hearing apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flow chart of a method for determining a frequency response according to the invention; and

FIG. 2 is a block diagram of a hearing apparatus for determining the frequency response.

### DESCRIPTION OF THE INVENTION

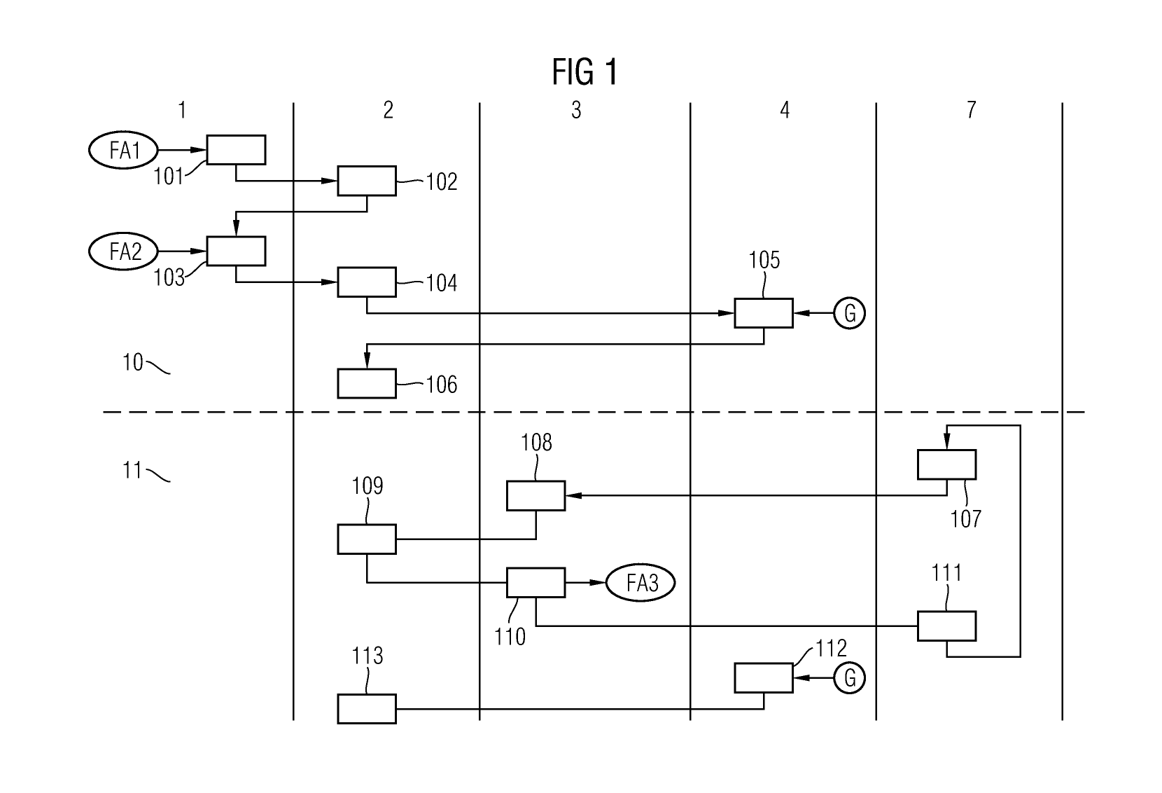

Referring now to the figures of the drawing in detail and first, particularly, to FIG. 1 dependent thereof, there is shown a flow chart of an inventive method for determining a frequency response of a hearing apparatus in any acoustic environment situation.

During a setting phase 11 of the hearing apparatus, preset, user-independent frequency responses FA1 are detected in the method step 101 by way of a data input unit 1. In step 102, the storage of the data detected using the data input unit 1 takes place in the storage unit 2. The steps 101 and 102 are typically still implemented during the manufacturing process of the hearing apparatus. In method step 103, user-dependent frequency responses FA2, which were determined within the scope of hearing tests, are detected by way of the data input unit 1 and stored in the storage unit 2 in step 104. The hearing tests are typically performed by a hearing device acoustician, but could however also be carried out by the wearer of the hearing apparatus him/herself in a computer-assisted manner. A weighting factor G is also set in step 105 by way of a setting device 4, the weighting factor G being stored in the storage unit 2 in step 106. In the operating phase 12, a signal processing unit 7 transmits a signal to a frequency response determination unit 3 in step 107. The associated hearing environment category is determined there in method step 108. The preset, user-independent frequency response FA1 assigned to the identified hearing environment category, the user-dependent frequency response FA2 and the current value of the weighting factor G are then called up in step 109 in the storage unit 2. On the basis of this data, the frequency response of the hearing apparatus FA3 is determined in the frequency response determination unit 3 in method step 110 and the signal processing unit 7 is prepared in step 111. Subsequently, step 107 is continued during operation and the next signal is transmitted from the signal processing unit 7 to the frequency response determination unit 3. During operation of the hearing apparatus, changes to the weighting factor G can be performed in step 112 at any time by way of the setting device 4. The changed weighting factor G is stored in the storage unit 2 in step 113.

The thus determined frequency responses are used to set the optimal frequency-dependent amplification of the hearing apparatus.

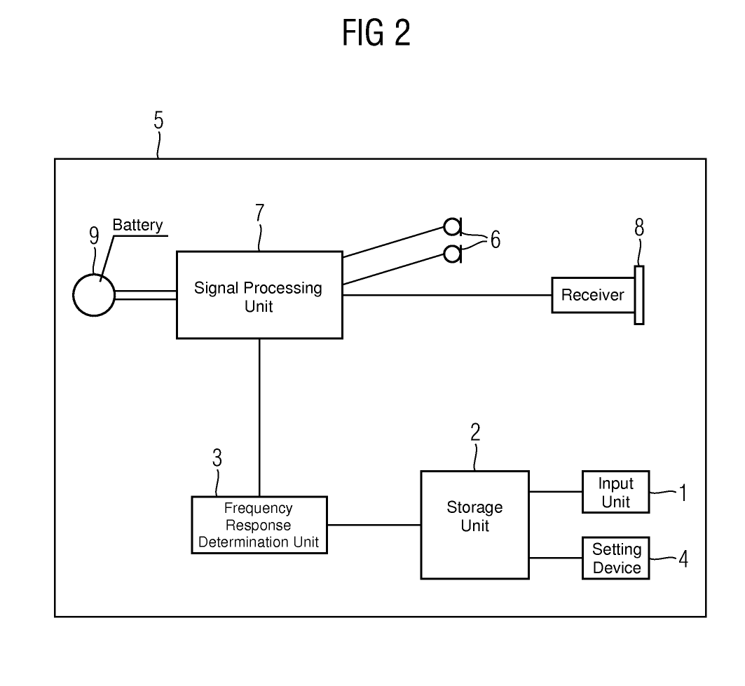

FIG. 2 shows a block diagram of an inventive hearing device with its essential components for determining a frequency response. One or more microphones 6 for receiving the sound from the environment are integrated into a hearing device housing 5 to be worn behind the ear. A signal processing unit 7, which is likewise integrated into the hearing device housing 5, processes the microphone signals and amplifies them. The output signal of the signal processing unit 7 is transmitted to a loudspeaker and/or receiver 8, which outputs an acoustic signal. The sound is if necessary transmitted via a sound tube, which is fixed to an otoplastic in the auditory canal, to the ear drum of the device wearer. The power supply of the hearing device and in particular that of the signal processing unit 7 takes place by a battery 9 which is likewise integrated into the hearing device housing 5. The data input unit 1 is connected to the storage unit 2 for transmitting the data detected in the data input unit 1. The connection is preferably realized wirelessly by way of a radio interface. The frequency response determination unit 3 likewise accesses the data stored in the storage unit 2 by way of a data interface. A setting of the weighting factor G can be performed by way of a setting device 4. The setting device 4 is connected to the storage unit 2. The performed settings are likewise stored in the storage unit 2. The frequency response determination unit 3 is connected to the signal processing unit 7 and receives the signals transmitted by the signal processing unit 7 and transfers the frequency response back to the signal processing apparatus 7 after determining said frequency response.

The invention can also be used with other hearing apparatuses, like for instance headphones.

1. A method for determining a frequency response of a hearing apparatus in any acoustic environment situation, which comprises the step of:
determining the frequency response of the hearing apparatus in dependence on at least one preset, user-independent frequency response and at least one user-dependent frequency response.

2. The method according to claim 1, wherein a user is a wearer of the hearing apparatus.

3. The method according to claim 1, which further comprises determining the user-dependent frequency response by means of audiological tests.

4. The method according to claim 3, which further comprises restricting a quantity of parameter settings offered during the audiological tests in order to determine the user-dependent frequency response in accordance with predeterminable criteria.

5. The method according to claim 3, which further comprises storing the user-dependent frequency response in the hearing apparatus.

6. The method according to claim 5, which further comprises storing the preset, user-independent frequency response in the hearing apparatus.

7. The method according to claim 1, which further comprises determining the frequency response of the hearing apparatus via a total of the preset, user-independent frequency response and a difference, weighted with a predeterminable weighting factor, between the user-dependent frequency response and the preset, user-independent frequency response.

8. A hearing apparatus for determining a frequency response in any acoustic environment situation, the hearing apparatus comprising:
a frequency response determination unit for changing the frequency response of the hearing apparatus in dependence on at least one preset, user-independent frequency response and at least one user-dependent frequency response.

9. The hearing apparatus according to claim 8, further comprising a storage unit for storing the preset, user-independent frequency responses and the user-dependent frequency responses, said storage unit connected to said frequency response determination unit.

10. The hearing apparatus according to claim 9, further comprising a data input unit connected to said storage unit.

11. The hearing apparatus according to claim 8, further comprising a setting device for changing a predeterminable weighting factor by a wearer of the hearing apparatus, with the frequency response of the hearing apparatus being determined by way of a total of the preset, user-independent frequency response and a difference, weighted with the predefinable weighting factor, between the user-dependent frequency response and the preset, user-independent frequency response.

12. The hearing apparatus according to claim 8, wherein the hearing apparatus is a hearing device.
